(19) United States
(12) Patent Application Publication
(10) Pub. No.: US 2012/0112447 A1
(43) Pub. Date: May 10, 2012

(54) SPLASH FLAP, PARTICULARLY FOR TRUCKS

(75) Inventor: Poul STIDSEN, Egaa (DK)

(73) Assignee: PSA Industri A/S

(21) Appl. No.: 13/291,202

(22) Filed: Nov. 8, 2011

(30) Foreign Application Priority Data
Nov. 9, 2010 (DK) PA 2010 70478

(51) Int. Cl. B62D 25/18

(52) U.S. Cl. 280/851

(57) ABSTRACT

A splash flap, particularly for trucks, of the kind including one or more splash flap parts for mounting internally in a curved mudguard (2), and a splash flap (6)for mounting on a mudguard part (4) depending from a lower rearmost edge part of the mudguard (2). The splash flap parts (6 and 18) include at least one spray reducing and liquid impeding means for decelerating and retaining water sprayed up from the wheels and for counteracting formation of a water mist from the splash flap and conducting retained water down from the splash flap. The splash flap parts (6 and 18) include mutually complementing coupling parts such that the at least one spray reducing and/or decelerating means of respective splash flap parts (6 and 18) is operatively coupled together without visible joints to form a unbroken interacting splash flap surface.

### CROSS-REFERENCE TO RELATED APPLICATION

Reference is made to Danish Application PA 2010 70478 which was filed on Nov. 9, 2010, which application in its entirety is incorporated herein fully by reference.

### BACKGROUND OF THE INVENTION

1. Field of the Invention

The present invention concerns a splash flap, particularly for lorries or trucks.

2. Description of the Prior Art

With the object of reducing or stopping the spray produced by the wheels of vehicles in wet conditions, it is well-known to mounted splash flaps on vehicles, in particular heavy vehicles.

It is prior art to have splash flaps that include spray reducing and/or liquid decelerating means adapted to impede and retain water which is sprayed backwards/upwards from the driving wheels and to conduct the retained water down from the splash flap or an associated mudguard.

Truck mudguards can be very bulky. Most often splash guards are fitted with spray reducing and/or liquid decelerating means both internally of the rearmost curving part of the mudguard and also depending from a lower rearmost edge part of the mudguard.

Coupling zones very often appear between functionally interconnected splash flaps where the spray reducing and/or liquid decelerating means are ineffective.

WO 93/12966A1 discloses a spray-suppression system for reducing the sprays caused by vehicle wheels. The spray-suppression system comprises the wheel's mudguard part, a rain flap part and a spray-suppression material layer fixed to the interior side thereof. At least a part of the mudguard part and the rain flap part are made in one part, to which the spray-suppression material layer is fixed. The rain flap part is either welded to the mudguard part or formed to be an integral part of it.

### SUMMARY OF THE INVENTION

The invention is a new and improved splash flap with spray reducing and/or liquid decelerating performed in an efficient way. In addition, the splash flap according to the invention has other substantial functional advantages.

The splash flap according to the invention includes the splash flap parts having mutually complementing coupling parts such that respective spray reducing and/or liquid decelerating means of the respective splash flap parts operatively and without visible joints can be coupled together to form an unbroken interacting splash flap surface.

By simple measures it hereby becomes possible to achieve a new and improved splash flap where particularly the problems of reduced function of coupling zones between interconnected spray reducing and/or liquid decelerating parts can be counteracted in an efficient way.

The splash flap according to the invention may suitably be designed such that the complementing coupling parts are constituted by spaced projecting fingers at and spaced apart from a rear side of a lower edge of a splash flap part, and by recesses provided at a rear side of an upper edge of a splash flap part spaced apart therefrom. The recesses form channels for receiving the projecting fingers by contact against an inner side of the mudguard.

With the object of simplifying the joining of individual splash flap parts, the splash flap according to the invention can be designed such that that the projecting fingers which are manufactured by injection moulding of a suitable plastic material, e.g. polyethylene (PE), are connected with a common transverse support strip which is spaced apart from the lower edge of the splash flaps and is connected with the splash flap by individual connecting members.

Correspondingly, it may be advantageous that the recesses are made by injection moulding a suitable plastic material, e.g. polyethylene (PE), in one piece. An upper transverse edge part of the splash flap is spaced behind the splash flap.

In a preferred embodiment, the splash flap according to the invention has the spray reducing and/or liquid decelerating parts in sheet profiles with longitudinal V-grooves alternatingly opening forwards and rearwards, respectively, in the transverse direction and extending perpendicularly to opposing ends of the splash flap where the forwardly open V-grooves are designed at the bottom with a series of a substantial number of openings which are preferably circular.

With the objective of simplifying mounting, the splash flap according to the invention can suitably be designed such that every other rearwardly open groove along a forwardly closed ridge is connected with the mudguard and the support strip, respectively, by the individual connecting members.

The splash flap according to the invention can further suitably be designed such that the individual connecting members include a tubular connecting member with a lower external collar within which is formed an annular cavetto for receiving a plate edge of a hole, for example in the mudguard. The tubular connecting member has an upwardly pointing ridge that fits with the rear side of the forwardly closed ridge of the rearwardly open groove. An upper stem with a head fits externally on the forwardly closed ridge of the rearwardly open groove. The stem has a projecting unilaterally sloping edge at a laser end for engaging and being fixed in an annular internal recess of the tubular connecting member.

### DESCRIPTION OF THE DRAWINGS

The invention is now explained in detail in connection with the drawing, in which:

FIG. 1 shows a view of an embodiment of a splash flap according to the invention shown during a first mounting step internally of a mudguard for a truck;

FIG. 2 shows a view of the embodiment shown in FIG. 1 of a splash flap according to the invention shown during a second mounting step internally of a mudguard for a truck;

FIG. 3 shows a view of the embodiment shown in FIG. 1 of a splash flap according to the invention shown during a third mounting step internally of a mudguard for a truck;

FIG. 4 shows a view of the embodiment shown in FIG. 1 of a splash flap according to the invention shown during a final mounting step internally of a mudguard for a truck;

FIG. 5 shows a view of the embodiment shown in FIG. 1 of a splash flap according to the invention shown mounted internally in a mudguard for a truck, that is viewed from a rear side of the mudguard;

FIG. 6 shows a view of an upper part of a splash flap according to the invention mounted internally of a mudguard, as seen from below;

FIG. 7 shows a view corresponding to that in FIG. 6, only as seen from a side;

FIG. 8 shows a view of a lower part of a splash flap according to the invention, shown mounted internally in a secondary mudguard part for mounting at a lower end of a mudguard for a lorry;

FIG. 9 shows a view of the secondary mudguard part according to the invention shown in FIG. 8, as seen from a lower end;

FIG. 10 shows a view of the secondary mudguard part and splash flap, respectively, according to the invention shown in FIGS. 8 and 9, as seen from a front side of the splash flap according to the invention;

FIG. 11 shows a perspective view of an upper part of a splash flap, as seen from a lower end part and rear side thereof, respectively;

FIG. 12 shows a lower end part of the upper splash flap according to the invention shown in FIG. 11, as seen from the rear;

FIG. 13 shows an upper end part of the upper splash flap according to the invention shown in FIG. 11, as seen from the rear;

FIG. 14 shows a view of an enlarged rear side of an upper splash flap part; and

FIG. 15 shows views of embodiments of connecting members for mounting a lower splash flap internally of a secondary lower mudguard.

### DETAILED DESCRIPTION OF THE INVENTION

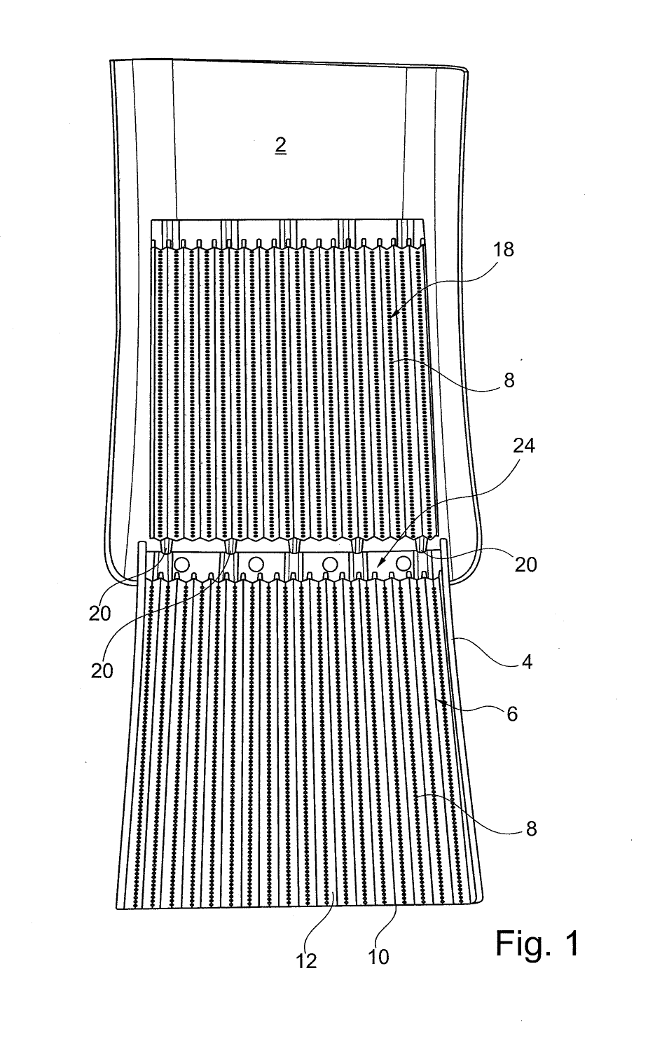

The mudguard 2 shown in FIGS. 1-5 is mounted with a further mudguard part 4 extending from a lower edge of the mudguard 2, on the forward facing side of which part 4 is fitted with a splash flap 6 which includes a spray reducing and/or liquid deceleration profiled plate 8 with longitudinal V-grooves 10 and 12 that are open forwardly and rearwardly alternatingly in the transverse direction. The grooves 10 and 12 extend perpendicularly to opposite ends of the splash flap 6, where the forward open V-grooves 10 are provided at the bottom with a row of a substantial number of openings 14 which are preferably circular.

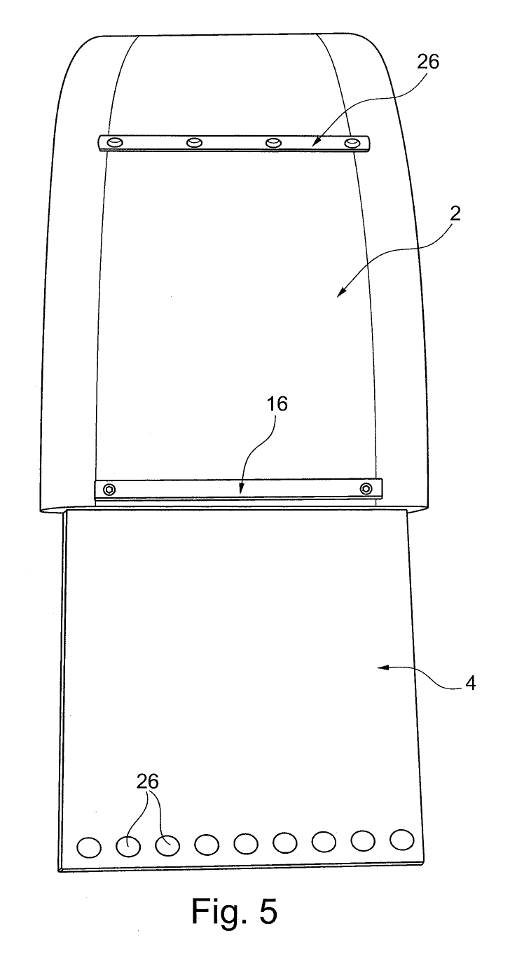

In FIG. 1 is shown how an upper transverse edge part 24 of the mudguard part 4 and the splash flap 6 is fastened by means of bolts, washers and nuts to a lower edge of the mudguard 2. FIG. 5 is also provided with a transverse metal strip 16 at the back side for reinforcing the splash flap 6.

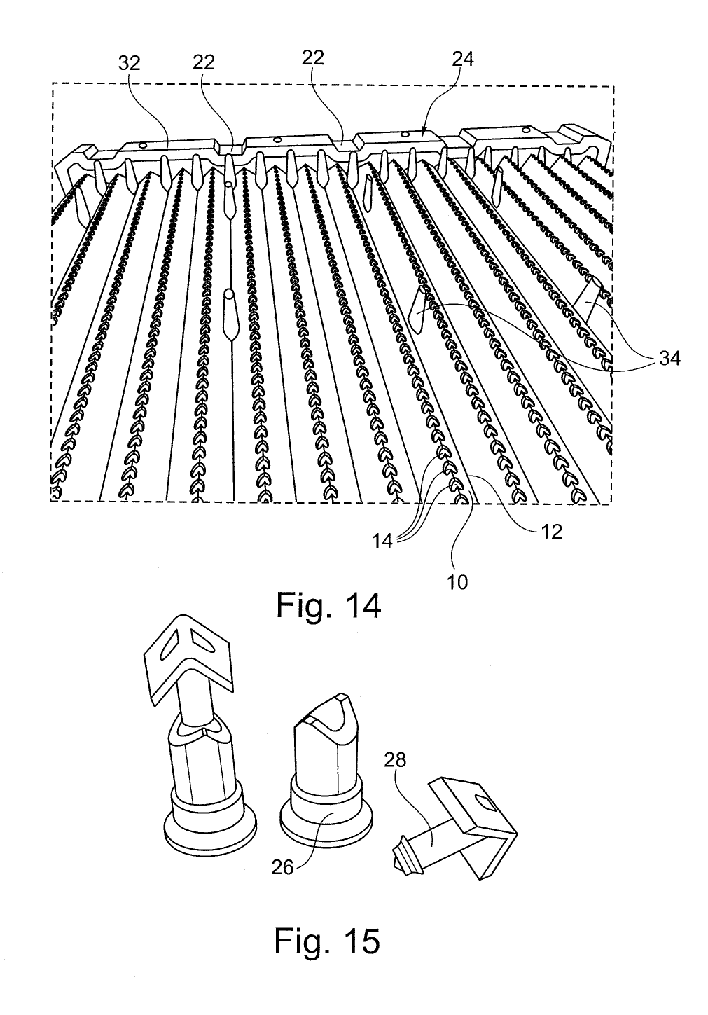

FIG. 1 shows an upper splash flap part 18 which is ready to be connected with the splash flap 6 by means of connecting fingers 20 (see also FIGS. 6-7 and FIGS. 11-12). The connecting fingers 20 of FIGS. 6, 11 and 12 are brought into a position opposite the upper recesses 22 as seen in FIGS. 13 and 14 between the back side of an upper edge part of the mudguard part 4 .

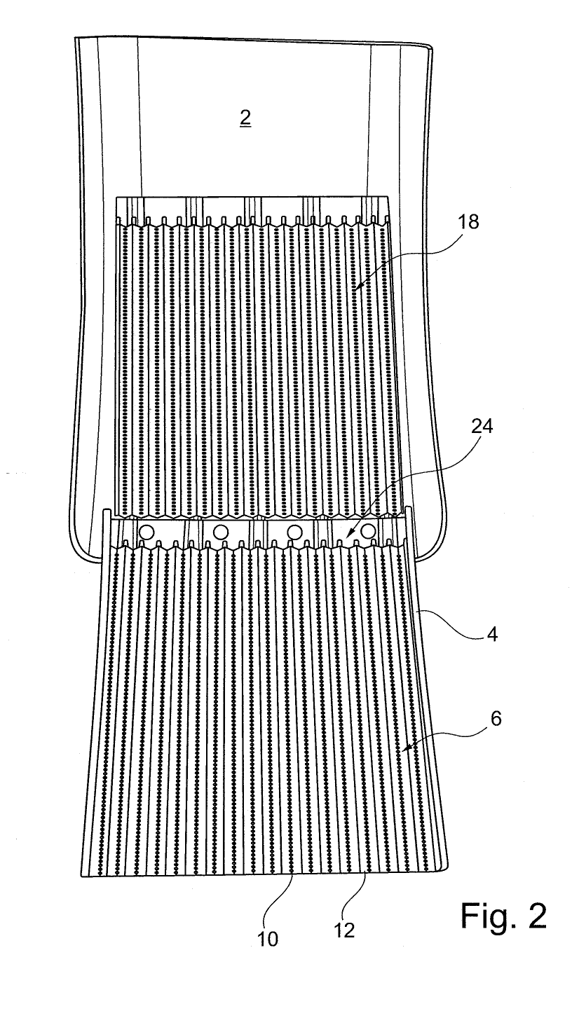

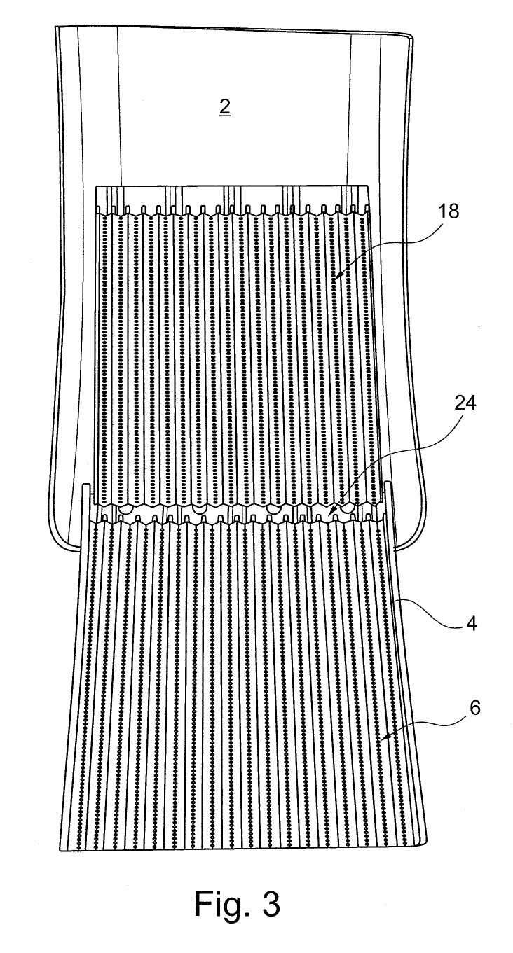

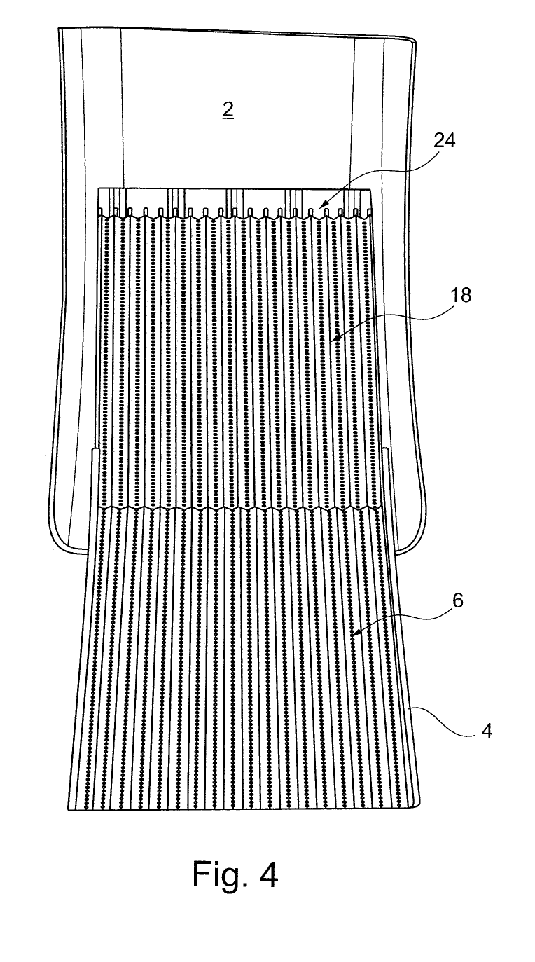

In FIGS. 2 and 3, the upper splash flap part 18 is brought into even tighter mutual connection when the connecting fingers 20 are inserted into the recesses 22 until the splash flap 6 and the splash flap part 18 are brought into close mutual contact as shown in FIG. 4 such that respective V-grooves 10 and 12 of the respective splash flap parts 6 and 18 are aligned with each other.

Finally, an upper transverse edge part 24 of the splash flap part 18 is fastened to the internal side of the mudguard 2 by bolts, washers and nuts. This fastening is furthermore provided at the rear side with a transverse metal strip 26 for reinforcing the fastening of the splash flap part 18 as shown in FIG. 5.

FIGS. 6 and 7 show how the splash flap part 18 can be fastened internally of the mudguard 2 where also the connecting fingers 20 protrude at the lower edge of the splash flap part 18.

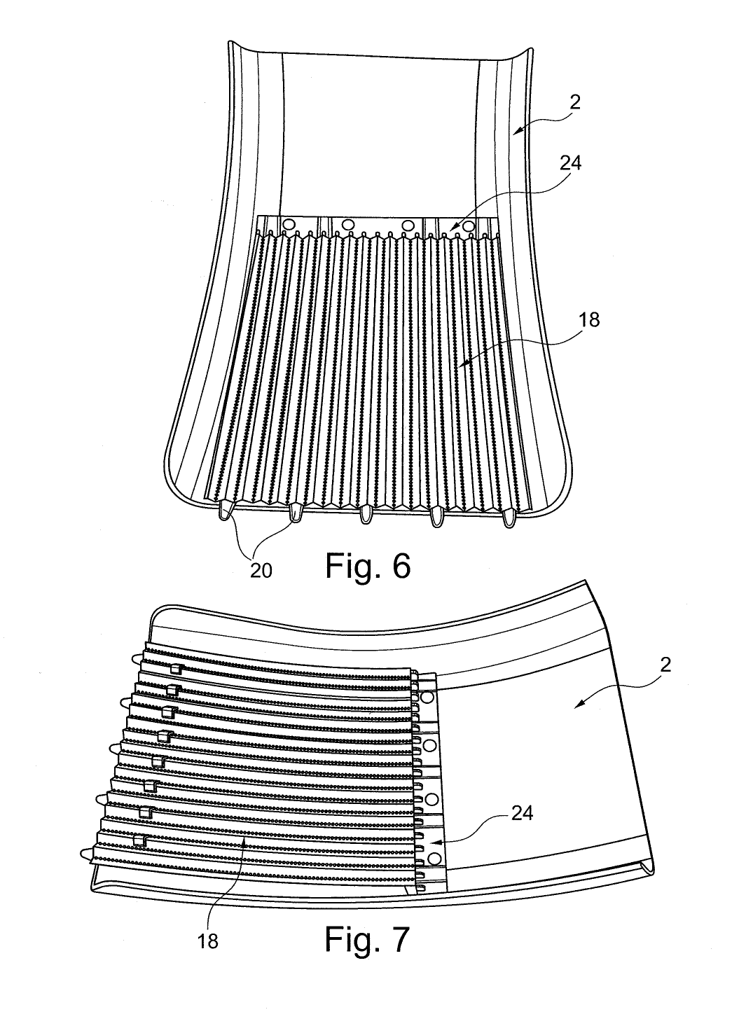

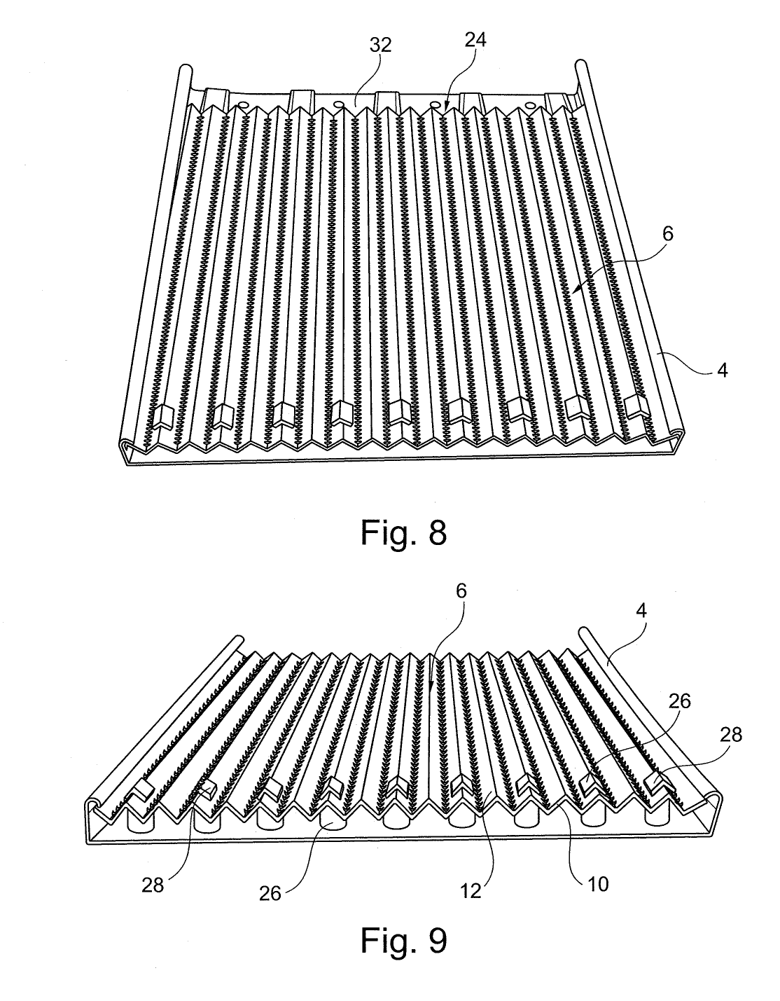

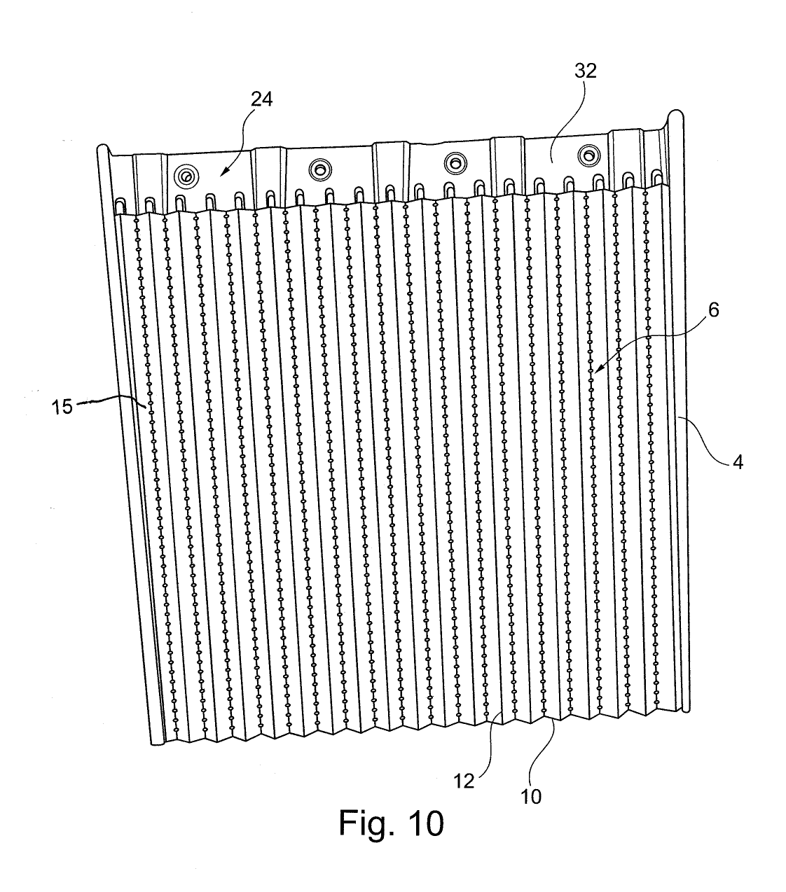

FIGS. 8-10 show how the splash flap 6 is mounted internally to the mudguard 4. FIG. 9 shows most clearly how the lower end of the splash flap 6 is fastened to the mudguard part 4 by individual connecting members 26 and 28 (FIG. 15) while FIG. 10 most clearly shows the upper edge part 15 of the splash flap.

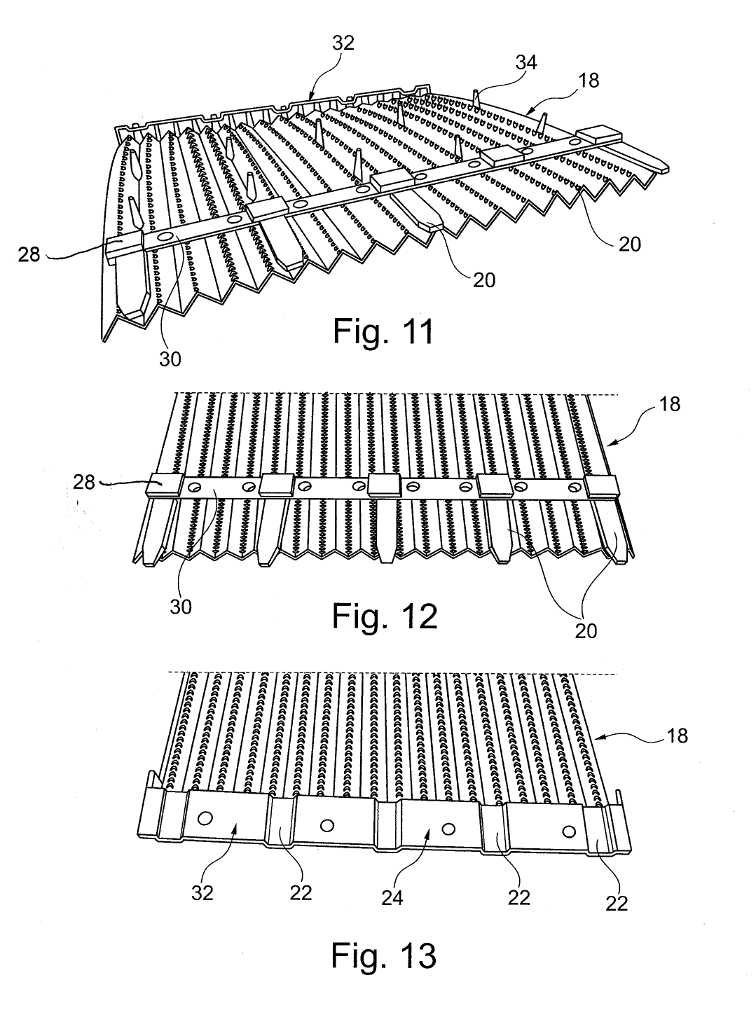

FIGS. 11 and 12 show the projecting connecting fingers 20 at a lower end of the splash flap part 18. The connecting fingers 20 are fastened to the splash flap part 18 by a common transverse support strip 30 which is connected with the splash flap part 18 by connecting parts 28. FIGS. 11 and 14 further show the transverse support strip 30 and spacers 34 that project from the rear side of the splash flap part 18.

FIG. 13 shows a rear side of the common edge part 24 and 32. The recesses 22 are at a rear side of the splash flap part 18. The feature that the edge part 32 is disposed with spacing behind the splash flap part 18 is seen more clearly in FIG. 14.

1-7. (canceled)

8. A splash flap, for trucks comprising:
at least one splash flap mounted internally in a curved mudguard, at least one second splash flap mounted on a mudguard extending from a lower rearmost edge of the current mudguard, the splash flaps including at least one of spray reducing and liquid impeding means for decelerating and retaining water sprayed up from wheels and for counteracting formation of a water mist from the at least one splash flaps and for conducting retained water down from the at least one splash flaps, wherein the at least one splash flaps include mutually complementing coupling parts providing operative coupling of the at least one spray reducing and liquid decelerating means of the at least one splash flaps together to form an unbroken interacting splash flap surface.

9. A splash flap according to claim 8, wherein the complementing coupling parts include spaced projecting fingers at and spaced apart from a rear side of a lower edge of one of splash flaps and recesses provided at a rear side of an upper edge of another of the at least one splash flap with the recesses forming channels for receiving the projecting fingers for contact against an inner side of the mudguard.

10. A splash flap according to claim 9, wherein the projecting fingers are injection moulded from plastic material and connected with a common transverse support strip which is spaced apart from the lower edge connected to the splash flap by connecting members.

11. A splash flap according to claim 9, wherein the recesses are a single piece of injection moulded plastic with an upper transverse edge disposed with a space behind the splash flaps.

12. A splash flap according to claim 8, wherein at least one of the spray reducing and liquid decelerating means are sheets with longitudinal V-grooves alternatingly opening forwardly and backwardly in a transverse direction and extending perpendicularly to opposing ends of one of the splash flaps with the forwardly opening V-grooves having openings at a bottom thereof.

13. A splash flap according to claim 8, wherein backwardly opening grooves extend along a forwardly closed ridge and are connected with one of the mudguards with a support strip by connecting members.

14. A splash flap according to claim 13, wherein the connecting members include a tubular connecting member with a lower external collar within which is formed a cavity for receiving a plate edge of a hole in the mudguard, the tubular connecting member including an upwardly extending pointed ridge fitting with a rear side of forwardly closed ridge of the backwardly open groove, and an upper part with a head extending externally from the forwardly closed ridge of the backwardly open groove, a stem at a lower end including a projecting unilaterally sloping edge which engages and is fixed in an annular internal recess of the tubular connecting member.
